(19) United States
(12) Patent Application Publication
(10) Pub. No.: US 2022/0174193 A1
(43) Pub. Date: Jun. 2, 2022

(54) OPTICAL SYSTEM, PHOTOGRAPHING MODULE, AND ELECTRONIC DEVICE

(71) Applicant: JIANGXI JINGCHAO OPTICAL CO., LTD., Nanchang, Jiangxi (CN)

(72) Inventors: Lu HUA, Nanchang (CN); Jian YANG, Nanchang (CN); Ming LI, Nanchang (CN)

(73) Assignee: JIANGXI JINGCHAO OPTICAL CO., LTD., Nanchang (CN)

(21) Appl. No.: 17/440,691

(22) PCT Filed: Jan. 6, 2020
(86) PCT No.: PCT/CN2020/070404

§ 371 Date: Sep. 17, 2021

(51) Int. Cl. H04N 5/225; G02B 9/34; G02B 13/00; G02B 3/04; G02B 1/04

(52) U.S. Cl. CPC H04N 5/2254; H04N 5/2252; G02B 1/041; G02B 13/004; G02B 3/04; G02B 9/34

(57) ABSTRACT

An optical system, sequentially comprising from an object side to an image side: a first lens having positive refractive power, an object side surface of the first lens being convex at the optical axis; a second lens having negative refractive power, an image side surface of the second lens being concave at the optical axis; a third lens having positive refractive power, an image side surface of the third lens being convex at the optical axis; and a fourth lens having negative refractive power, an image side surface of the fourth lens being concave at the optical axis. The optical system further satisfy the following relation: 0.28<M<1.3, M being the magnification of the optical system.

### CROSS REFERENCE TO RELATED APPLICATION

The present application is a national stage of International Application No. PCT/CN2020/070404, filed on 6 Jan. 2020, the content of which is incorporated herein by reference in its entirety.

### TECHNICAL FIELD

The present disclosure relates to relates to a field of optical imaging, in particular to an optical system, a camera module, and an electronic device.

### BACKGROUND

In recent years, with the continuous development of hardware and software and manufacturing technologies related to smartphones, consumers have increasingly demanded diversified functions and high-quality imaging quality of lenses of the phone. In addition, whether a picture with clear image quality can be captured under different capturing conditions is a key factor for selecting which electronic product is modern people. Especially, in the macro capturing, it is difficult for a conventional camera lenses to image a subject in macro clearly, resulting in the blurred image, and main details of the subject cannot be presented well.

### SUMMARY

According to embodiments of the present disclosure, an optical system, a camera module, and an electronic device are provided.

An optical system includes, sequentially from an object side to an image side:

a first lens having a positive refractive power, an object side surface of the first lens being convex at an optical axis;

a second lens having a negative refractive power, an image side surface of the second lens being concave at the optical axis;

a third lens having a positive refractive power, and an image side surface of the third lens being convex at the optical axis; and

a fourth lens having a negative refractive power, and an image side surface of the fourth lens being concave at the optical axis;

wherein the optical system further satisfies a condition:

0.28<M<1.3;

wherein M is a magnification of the optical system.

A camera module includes a photosensitive element and the optical system as described above. The photosensitive element is arranged on an image side of the fourth lens.

An electronic device includes a housing and the camera module as described above. The camera module is provided on the housing.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIG. 1 is a schematic view of an optical system according to a first embodiment of the present disclosure.

FIG. 2 is a graph showing spherical aberration (mm), astigmatism (mm), and distortion (%) of the optical system according to the first embodiment.

FIG. 3 is a schematic view of an optical system according to a second embodiment of the present disclosure.

FIG. 4 is a graph showing spherical aberration (mm), astigmatism (mm), and distortion (%) of the optical system according to the second embodiment.

FIG. 5 is a schematic view of an optical system according to a third embodiment of the present disclosure.

FIG. 6 is a graph showing spherical aberration (mm), astigmatism (mm), and distortion (%) of the optical system according to the third embodiment.

FIG. 7 is a schematic view of an optical system according to a fourth embodiment of the present disclosure.

FIG. 8 is a graph showing spherical aberration (mm), astigmatism (mm), and distortion (%) of the optical system according to the fourth embodiment.

FIG. 9 is a schematic view of an optical system according to a fifth embodiment of the present disclosure.

FIG. 10 is a graph showing spherical aberration (mm), astigmatism (mm), and distortion (%) of the optical system according to the fifth embodiment.

FIG. 11 is a schematic view of an optical system according to a sixth embodiment of the present disclosure.

FIG. 12 is a graph showing spherical aberration (mm), astigmatism (mm), and distortion (%) of the optical system according to the sixth embodiment.

FIG. 13 is a schematic view of an optical system according to a seventh embodiment of the present disclosure.

FIG. 14 is a graph showing spherical aberration (mm), astigmatism (mm), and distortion (%) of the optical system according to the seventh embodiment.

FIG. 15 is a schematic view of a camera module according to an embodiment of the present disclosure.

FIG. 16 is a schematic view of an electronic device according to an embodiment of the present disclosure.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the disclosure of the present disclosure more thorough and comprehensive.

It should be noted that when an element is referred to as being “fixed to” another element, it can be directly on another element or an intervening element may also be present therebetween. When an element is considered to be “connected to” another element, it can be directly connected to another element or an intervening element may be present at the same time. Terms “inner”, “outer”, “left”, “right” and similar expressions used herein are for illustrative purposes only, and do not mean that they are the only embodiments.

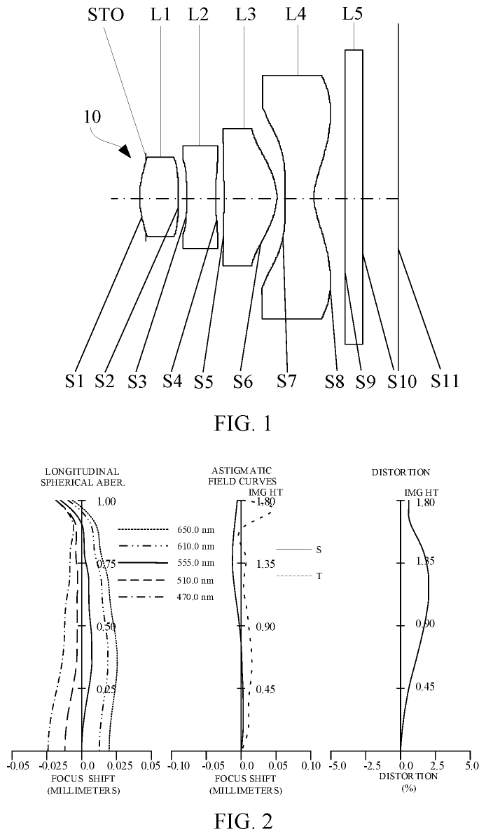

Referring to FIG. 1, in an embodiment of the present disclosure, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. The lenses and the stop STO in the optical system 10 are coaxially arranged. That is, centers of the lenses and the stop STO are located on the same straight line. This straight line may be referred to as an optical axis of the optical system 10 or a first optical axis. A projection of the stop STO on the first optical axis overlaps a projection of the first lens L1 on the first optical axis. Of course, in some embodiments, the projection of the stop STO on the first optical axis may not overlap the projection of the first lens L1 on the first optical axis. In this embodiment, the relative positions between the lenses in the optical system 10 are fixed, or it can be understood that a distance between each adjacent lenses on the optical axis is fixed, so as to form an optical system having a fixed focal length.

In this embodiment, the first lens L1, the second lens L2, the third lens L3, and the fourth lens L4 each include only one lens. However, it should be noted that in some embodiments, any one of the first lens L1, the second lens L2, the third lens L3, and the fourth lens L4 may be a lens group composed of two or more lenses. For example, the first lens L1, the second lens L2, and the third lens L3 each include only one lens, and the fourth lens L4 is composed of two or more lenses. Alternatively, the first lens L1 and the second lens L2 each include only one lens, and the third lens L3 and the fourth lens L4 each include two lenses.

The first lens L1 includes an object side surface S1 and an image side surface S2. The second lens L2 includes an object side surface S3 and an image side surface S4. The third lens L3 includes an object side surface S5 and an image side surface S6. The fourth lens L4 includes an object side surface S7 and an image side surface S8. In addition, the optical system 10 has an imaging plane S11. The imaging plane S11 is located on an image side of the fourth lens L4. Incident light can be imaged on the imaging plane S11 after being adjusted by the lenses of the optical system 10. To facilitate understanding, the imaging plane S11 can be regarded as a photosensitive surface of a photosensitive element. The optical system 10 further has an object plane, and a subject on the object plane can be imaged clearly on the imaging plane S11 of the optical system 10.

In this embodiment, the object side surface S1 of the first lens L1 is convex at the optical axis. The image side surface S4 of the second lens L2 is concave at the optical axis. The image side surface S6 of the third lens L3 is convex at the optical axis. The image side surface S8 of the fourth lens L4 is concave at the optical axis. When satisfying the above refractive powers and surface shape conditions of the lenses, it is beneficial for the optical system 10 to be applied in the macro capturing and to realize a miniaturized design.

In this embodiment, the object side surface and the image side surface of each of the first lens L1 to the fourth lens L4 are all aspherical. The configuration of the aspherical surface shape can effectively help the optical system 10 to eliminate aberrations and solve the problem of distortion of the field of view. As such, it is also beneficial to the miniaturized design of the optical system 10, so that the optical system 10 can have excellent optical effects on the premise of maintaining the miniaturized design. In other embodiments, at least one of the object side surfaces and the image side surfaces of the lenses of the optical system 10 is aspherical. For example, only the image side surface S8 of the fourth lens L4 may be configured to be aspherical, or only the object side surface S7 and the image side surface S8 of the fourth lens L4 are configured to be aspherical, to facilitate final correction of the aberrations of the system.

The surface shape of the aspheric surface can be calculated by referring to the following aspheric formula:

$$Z = \frac{c {r}^{2}}{1 + \sqrt{1 - ( k + 1 ) {c}^{2} {r}^{2}}} + {\sum }_{i} {Air}^{i}$$

where, Z is a distance from a corresponding point on an aspheric surface to a plane tangent to a vertex of the surface, r is a distance from a corresponding point on the aspheric surface to the optical axis, c is a curvature of the vertex of the aspheric surface, k is a conic coefficient, and Ai is a coefficient corresponding to the i^{th} high-order term in the aspheric surface shape formula.

In another aspect, it should be noted that when describing that a side surface of the lens at the optical axis (a central area of the side surface) is convex in an embodiment of the present disclosure, it can be understood that an area of this side surface of the lens close to the optical axis is convex. Therefore, it can also be determined that the side surface is convex at its paraxial area. When describing a side surface of the lens is concave at its circumference, it can be understood that an area of the side surface is concave when approaching the maximum effective radius. For example, when the side surface is convex at the optical axis and is also convex at its circumference, a shape of the side surface in a direction from its center (the optical axis) to its edge may be completely convex, or may be first convex at its center and be then transitioned to be concave, and then become convex when approaching the maximum effective radius. These are only examples to illustrate various shapes and structures (concave-convex condition) of the side surface at the optical axis and the circumference, and the various shapes and structures (concave-convex condition) of the side surface are not fully described, but other situations can be derived from the above examples, and should be considered as contents disclosed in the present disclosure.

In some embodiments, the image side surface S8 of the fourth lens L4 has an inflection point, and the image side surface S8 is concave at the optical axis and is convex at its circumference. When the fourth lens L4 satisfies the above surface shape, it is beneficial to shorten the total length of the optical system 10, while effectively reducing the incidence angle of light when being incident from the edge of field of view onto the imaging plane S11, and improving the light-receiving efficiency of the photosensitive element on the imaging plane S11.

In some embodiments, the stop STO may also be arranged between two adjacent lenses of the optical system 10. For example, the stop STO may be arranged between the first lens L1 and the second lens L2, between the second lens L2 and the third lens L3, or between the third lens L3 and the fourth lens L4.

In some embodiments, the first lens L1, the second lens L2, the third lens L3, and the fourth lens L4 are all made of plastic. In other embodiments, the first lens L1 is made of glass, and the second lens L2, the third lens L3, and the fourth lens L4 are all made of plastic. As such, since the lenses on the object side of the optical system 10 are made of glass, the lenses made of glass on the object side have a good resistance to extreme environments, and are not susceptible to aging and the like due to the impact of the environment on the object side. Therefore, when the optical system 10 is in the extreme environments such as exposed to the sun or in high temperature environment, the optical system 10 having this structure can effectively avoid the deterioration of the imaging quality and reduction of the service life of the optical system 10. The lens made of plastic can reduce the weight of the optical system 10 and production cost, while the lens made of glass can withstand higher temperatures and has excellent optical performance. In some embodiments, the lenses in the optical system 10 are all made of glass, and thus the lenses made of glass has excellent optical characteristics. Of course, the material configuration of each lens in the optical system 10 is not limited to the above embodiments, and any lens may be made of plastic or glass.

In some embodiments, the optical system 10 includes an infrared cut-off filter L5. The infrared cut-off filter L5 includes an object side surface S9 and an image side surface S10. The infrared cut-off filter L5 is used to filter out infrared light and prevent the infrared light from reaching the imaging plane S11, thereby preventing the infrared light from interfering with normal imaging. The infrared cut-off filter L5 can be assembled with the lenses as a part of the optical system 10. Alternatively, when the optical system 10 and the photosensitive element are assembled into a camera module, the infrared cut-off filter L5 is mounted between the optical system 10 and the photosensitive element. In some embodiments, the infrared cut-off filter L5 may also be arranged on the object side of the first lens L1. In addition, in some embodiments, the infrared cut-off filter L5 may not be provided, but a filter coating is provided on any one of the first lens L1 to the fourth lens L4 to achieve the effect of filtering the infrared light.

As above, in some embodiments, in addition to the lenses having the refractive powers, the optical system 10 may include a stop STO, an infrared cut-off filter L5, a protective glass, a photosensitive element, a reflector for changing an incident light path, and other elements.

In some embodiments, the optical system 10 satisfies the following condition:

0.28<M<1.3;

where M is a magnification of the optical system 10. In some embodiments, the M may be 0.35, 0.40, 0.50, 0.55, 0.60, 0.70, 0.80, 0.90, 1.00, 1.10, 1.15, or 1.20. When the above condition is satisfied, the optical system 10 will have an effect of large magnification while achieving miniaturization, so that more details of the subject can be obtained during macro capturing, and the imaging quality of the details of the subject can be improved. When the above condition is lower than the lower limit, it will be difficult to obtain more details of the subject. When the above condition is higher than the upper limit, it will be disadvantageous to the miniaturized design of the optical system.

In some embodiments, the optical system 10 satisfies the following condition:

3.3<TT/Imgh<7.4;

where TT is a distance from the object plane to the imaging plane of the optical system 10 on the optical axis, and Imgh is half of a diagonal length of an effective pixel area on the imaging plane of the optical system 10. In some embodiments, the TT/Imgh may be 3.40, 3.50, 3.70, 4.00, 4.50, 5.00, 6.00, 6.50, 7.00, 7.10, 7.20, or 7.30. When the above condition is satisfied, the optical system 10 can achieve a large magnification effect within a minute capturing distance, so that more details of the subject can be captured.

In some embodiments, the optical system 10 satisfies the following condition:

TTL/Imgh<2.5;

where TTL is a distance from the object side surface S1 of the first lens L1 to the imaging plane S11 of the optical system 10 on the optical axis, and Imgh is half of the diagonal length of the effective pixel area on the imaging plane S11 of the optical system 10. In some embodiments, the TTL/Imgh may be 1.70, 1.75, 1.80, 1.85, 2.00, 2.10, 2.20, 2.30, 2.40, 2.41, 2.42, or 2.43. When the above condition is satisfied, the optical system 10 can achieve a miniaturized design.

In some embodiments, the optical system 10 satisfies the following condition:

−1<f1/f2<0;

where f1 is an effective focal length of the first lens L1, and f2 is an effective focal length of the second lens L2. The first lens L1 provides a positive refractive power for the optical system 10, thereby facilitating better convergence of light and entry of the light into the optical system 10, and ensuring the telephoto characteristics of the system. In some embodiments, the f1/f2 may be −0.95, −0.90, −0.80, −0.70, −0.50, −0.40, −0.30, −0.25, −0.24, −0.23, or −0.22. When the above condition is satisfied, the second lens L2 can diverge the light passing through the first lens L1, thereby effectively correcting aberrations.

In some embodiments, the optical system 10 satisfies the following condition:

2<TTL/f<4;

where TTL is a distance from the object side S1 of the first lens L1 to the imaging plane S11 of the optical system 10 on the optical axis, and f is an effective focal length of the optical system 10. In some embodiments, the TTL/f may be 2.20, 2.30, 2.40, 3.00, 3.20, 3.40, 3.60, 3.65, or 3.70. Since the optical system 10 can achieve a miniaturized design, the optical system 10 is required to have a focal length that matches the structure of the system while satisfying high-definition imaging performance. Accordingly, when the above condition is satisfied, the focal length and the total optical length of the optical system 10 can be reasonably configured, so that the sensitivity of the optical system 10 can be reduced, and aberrations can be corrected.

In some embodiments, the optical system 10 satisfies the following condition:

1.8<(f1+f3)/f<3.2;

where f1 is an effective focal length of the first lens L1, f3 is an effective focal length of the third lens L3, and f is an effective focal length of the optical system 10. In some embodiments, the (f1+f3)/f may be 1.85, 1.90, 2.00, 2.20, 2.50, 2.80, 3.00, 3.05, 3.10, or 3.15. When the above condition is satisfied, the effective focal length of the first lens L1, the effective focal length of the third lens L3, and the effective focal length of the optical system 10 can be distributed reasonably, so as to ensure that the optical system 10 has a reasonable magnification during applying the macro imaging, thereby improving effective recognition accuracy. In addition, the above configuration can also reduce the aberration of the optical system 10 and improve the imaging quality of the optical system 10 during macro capturing.

In some embodiments, the optical system 10 satisfies the following condition:

2<R1/R8<4.5;

where R1 is a radius of curvature of the object side surface S1 of the first lens L1 at the optical axis, and R8 is a radius of curvature of the image side surface S8 of the fourth lens L4 at the optical axis. In some embodiments, the R1/R8 may be 2.10, 2.20, 2.30, 2.50, 2.80, 3.50, 3.80, 4.00, 4.10, or 4.20. When the above condition is satisfied, the incidence angle when light enters the optical system 10 can be reduced, so that the optical system 10 has a smaller angle of field of view.

In some embodiments, the optical system 10 satisfies the following condition:

1.4<CT3/CT2<4;

where CT2 is a thickness of the second lens L2 on the optical axis, and CT3 is a thickness of the third lens L3 on the optical axis. In some embodiments, the CT3/CT2 may be 1.50, 1.55, 1.60, 1.80, 2.00, 2.50, 3.00, 3.50, 3.60, 3.65, or 3.70. When the above condition is satisfied, it is beneficial for the second lens L2 and the third lens L3 to cooperate with each other in shape, thereby effectively improving the relative brightness around the system, and improving the yield rate when assembling the lenses.

In some embodiments, the optical system 10 satisfies the following condition:

0<|SAG41|/CT4<0.7;

where SAG41 is a sagittal height of the object side surface S7 of the fourth lens L4. That is, SAG41 is a horizontal displacement in a direction parallel to the optical axis from an intersection of the object side surface S7 of the fourth lens L4 on the optical axis to a position of the maximum effective radius of the object side surface S7 of the fourth lens L4 (the horizontal displacement is defined as positive toward the image side, and negative toward the object side surface). CT4 is a thickness of the fourth lens L4 on the optical axis. In some embodiments, the |SAG41|/CT4 may be 0.020, 0.030, 0.050, 0.100, 0.150, 0.200, 0.300, 0.500, 0.600, 0.640, 0.650, or 0.660. When the above condition is satisfied, it is possible to reduce the incidence angle of the main light on the imaging plane of the optical system 10, while effectively controlling the incidence angle of the light at the maximum field of view when approaching the object side surface S7 of the fourth lens L4. In addition, when the slope of the object side surface S7 of the fourth lens L4 changes greatly, the light reflected by the object side S7 due to uneven coating can be reduced, thereby avoiding stray light.

In some embodiments, when satisfying the above conditions, the optical system 10 has the characteristics of a small field of view and a short focal length, and has a higher relative illumination, as well as a small depth of field to highlight the subject and blur the background. In addition, the imaging quality of the details of the nearby subject during macro capturing can be further effectively improved.

Next, the optical system 10 of the present disclosure will be described in more specific and detailed embodiments.

### First Embodiment

Referring to FIGS. 1 and 2, in the first embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the first embodiment is included in FIG. 2. The astigmatism diagram and the distortion diagram are graphs at a wavelength of 555 nm.

Ordinates of the astigmatism diagram and the distortion diagram can be understood as half of a diagonal length of an effective pixel area on an imaging plane S11 of the optical system 10, in unit of mm.

An object side surface S1 of the first lens L1 is convex at the optical axis and is convex at its circumference. An image side surface S2 of the first lens L1 is convex at the optical axis and is convex at its circumference.

An object side surface S3 of the second lens L2 is convex at the optical axis and is concave at its circumference. An image side surface S4 of the second lens L2 is concave at the optical axis and is concave at its circumference.

An object side surface S5 of the third lens L3 is concave at the optical axis and is concave at its circumference. An image side surface S6 of the third lens L3 is convex at the optical axis and is concave at its circumference.

An object side surface S7 of the fourth lens L4 is concave at the optical axis and convex at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the first embodiment, the optical system 10 satisfies the following conditions:

M=0.58; where M is a magnification of the optical system 10. When the above condition is satisfied, the optical system 10 will have an effect of large magnification while achieving miniaturization, so that more details of the subject can be obtained during macro capturing, and the imaging quality of the details of the subject can be improved.

TT/Imgh=3.889; where TT is a distance from the object plane to the imaging plane of the optical system 10 on the optical axis, and Imgh is half of a diagonal length of an effective pixel area on the imaging plane of the optical system 10. When the above condition is satisfied, the optical system 10 can achieve a large magnification effect within a minute capturing distance, so that more details of the subject can be captured.

TTL/Imgh=1.694; where TTL is a distance from the object side surface S1 of the first lens L1 to the imaging plane S11 of the optical system 10 on the optical axis, and Imgh is half of the diagonal length of the effective pixel area on the imaging plane S11 of the optical system 10. When the above condition is satisfied, the optical system 10 can achieve a miniaturized design.

f1/f2=−0.463; where f1 is an effective focal length of the first lens L1, and f2 is an effective focal length of the second lens L2. The first lens L1 provides a positive refractive power for the optical system 10, thereby facilitating better convergence of light and entry of the light into the optical system 10, and ensuring the telephoto characteristics of the system. When the above condition is satisfied, the second lens L2 can diverge the light passing through the first lens L1, thereby effectively correcting aberrations.

TTL/f=2.293; where TTL is a distance from the object side surface S1 of the first lens L1 to the imaging plane S11 of the optical system 10 on the optical axis, and f is an effective focal length of the optical system 10. Since the optical system 10 can achieve a miniaturized design, the optical system 10 is required to have a focal length that matches the structure of the system while satisfying high-definition imaging performance. Accordingly, when the above condition is satisfied, the focal length and the total optical length of the optical system 10 can be reasonably configured, so that the sensitivity of the optical system 10 can be reduced, and aberrations can be corrected.

(f1+f3)/f=1.820; where f1 is an effective focal length of the first lens L1, f3 is an effective focal length of the third lens L3, and f is an effective focal length of the optical system 10. When the above condition is satisfied, the effective focal length of the first lens L1, the effective focal length of the third lens L3, and the effective focal length of the optical system 10 can be distributed reasonably, so as to ensure that the optical system 10 has a reasonable magnification during applying the macro imaging, thereby improving effective recognition accuracy. In addition, the above configuration can also reduce the aberration of the optical system 10 and improve the imaging quality of the optical system 10 during macro capturing.

R1/R8=2.036; where R1 is a radius of curvature of the object side surface S1 of the first lens L1 at the optical axis, and R8 is a radius of curvature of the image side surface S8 of the fourth lens L4 at the optical axis. When the above condition is satisfied, the incidence angle when light enters the optical system 10 can be reduced, so that the optical system 10 has a smaller angle of field of view.

CT3/CT2=1.824; where CT2 is a thickness of the second lens L2 on the optical axis, and CT3 is a thickness of the third lens L3 on the optical axis. When the above condition is satisfied, it is beneficial for the second lens L2 and the third lens L3 to cooperate with each other in shape, thereby effectively improving the relative brightness around the system, and improving the yield rate when assembling the lenses.

|SAG41|/CT4=0.676; where SAG41 is a sagittal height of the object side surface S7 of the fourth lens L4. That is, SAG41 is a horizontal displacement in a direction parallel to the optical axis from an intersection of the object side surface S7 of the fourth lens L4 on the optical axis to a position of the maximum effective radius of the object side surface S7 of the fourth lens L4 (the horizontal displacement is defined as positive toward the image side, and negative toward the object side surface). CT4 is a thickness of the fourth lens L4 on the optical axis. When the above condition is satisfied, it is possible to reduce the incidence angle of the main light on the imaging plane of the optical system 10, while effectively controlling the incidence angle of the light at the maximum field of view when approaching the object side surface S7 of the fourth lens L4. In addition, when the slope of the object side surface S7 of the fourth lens L4 changes greatly, the light reflected by the object side S7 due to uneven coating can be reduced, thereby avoiding stray light.

When satisfying the above conditions, the optical system 10 will have the characteristics of a small field of view and a short focal length, and has a higher relative illumination, as well as a small depth of field to highlight the subject and blur the background. In addition, the imaging quality of the details of the nearby subject during macro capturing can be further effectively improved.

In addition, various parameters of the lenses of the optical system 10 are shown in Table 1 and Table 2. In table 2, k is a conic coefficient, and Ai is a coefficient corresponding to the i^{th} high-order term in the aspheric surface shape formula. The elements from the object plane to the imaging plane S11 are arranged in the order of the elements in Table 1 from top to bottom. A subject on the object plane can be imaged clearly on the imaging plane S11 of the optical system 10. The surface numbers 1 and 2 indicate the object side surface S1 and the image side surface S2 of the first lens L1, respectively. That is, in the same lens, the surface with the smaller surface number is the object side surface, and the surface with the larger surface number is the image side surface. The Y radius in Table 1 is the radius of curvature of the object side surface or image side surface indicated by corresponding surface number at the paraxial area (or understood as “on the optical axis”). In the “thickness” parameter column of a lens, the first value is the thickness of the lens on the optical axis, and the second value is a distance from the image side surface of the lens to the object side surface of the latter lens on the optical axis. The value of the stop STO in the “thickness” parameter column is the distance from the stop STO to the vertex (the vertex refers to the intersection of the lens and the optical axis) of the object side surface of the latter lens (which is the first lens L1 in the embodiment) on the optical axis. Here, the default is that the direction from the object side surface of the first lens L1 to the image side surface of the last lens is the positive direction of the optical axis. When the value is negative, it indicates that the stop STO is arranged on the right side of the vertex of the object side surface of the lens (or understood as “on the image side of the vertex”). When the value of the “thickness” parameter of the stop STO is positive, the stop STO is on the left side of the vertex of the object side surface of the lens (or understood as “on the object side of the vertex”). In this embodiment, a projection of the stop STO on a first optical axis partially overlap a projection of the first lens L1 on the first optical axis. In the embodiment of the present disclosure, the optical axes of the lenses are on the same straight line. The straight line is used as the optical axis of the optical system 10. The value of the “thickness” parameter indicated by the surface number 8 is a distance from the image side surface S8 of the fourth lens L4 to the object side surface S9 of the infrared cut-off filter L5 on the optical axis. The value of the “thickness” parameter corresponding to the surface number 10 for the infrared cut-off filter L5 is a distance from the image side surface S10 of the infrared cut-off filter L5 to the image plane (the imaging plane S11) of the optical system 10 on the optical axis.

In the first embodiment, the effective focal length of the optical system 10 is indicated by f, and f=1.33 mm. The f-number is indicated by FNO, and FNO=3.05. The maximum angle of field of view (diagonal angle of field of view) is indicated by FOV, and FOV=75.7°. The total optical length is indicated by TTL, and TTL=3.05 mm TTL is a distance from the object side surface S1 of the first lens L1 to the imaging plane S11 of the optical system 10 on the optical axis.

In addition, in the following embodiments (the first embodiment, a second embodiment, a third embodiment, a fourth embodiment, a fifth embodiment, a sixth embodiment, and a seventh embodiment), the refractive indexes, the abbe numbers, and the focal lengths of the lenses are values at a wavelength of 555 nm. In addition, the calculation of the conditions and the structures of the lenses in each embodiment are based on the parameters of the lenses (such as parameters in Table 1, Table 2, Table 3, Table 4, etc.).

TABLE 1
First Embodiment
f = 1.33 mm, FNO = 3.05, FOV = 75.7° , TTL = 3.05 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 4.018 | | | | |
| 0 | Stop | Spherical | Infinite | −0.068 | | | | |
| 1 | First Lens | Aspherical | 0.924 | 0.453 | Plastic | 1.55 | 56.11 | 1.52 |
| 2 | | Aspherical | −6.826 | 0.100 | | | | |
| 3 | Second Lens | Aspherical | 136.716 | 0.340 | Plastic | 1.64 | 23.52 | −3.28 |
| 4 | | Aspherical | 2.081 | 0.100 | | | | |
| 5 | Third Lens | Aspherical | −9.278 | 0.621 | Plastic | 1.55 | 56.11 | 0.90 |
| 6 | | Aspherical | −0.480 | 0.100 | | | | |
| 7 | Fourth Lens | Aspherical | −1000.000 | 0.340 | Plastic | 1.55 | 56.11 | −0.83 |
| 8 | | Aspherical | 0.454 | 0.368 | | | | |
| 9 | Infrared | Spherical | Infinite | 0.210 | Glass | 1.52 | 64.17 | |
| 10 | Cut−off Filter | Spherical | Infinite | 0.417 | | | | |
| 11 | Image plane | Spherical | Infinite | 0.000 | | | | |

Note the reference wavelength is 555 nm

TABLE 2
First Embodiment
Aspheric Coefficient

| Surface | | | | | |
|---|---|---|---|---|---|
| Number | K | A4 | A6 | A8 | A10 |
| 1 | −1.9276E+00 | 1.6794E−01 | −2.1180E+00 | 6.5996E+01 | −1.3276E+03 |
| 2 | 2.0000E+01 | −1.1995E+00 | −1.9877E+00 | 4.0620E+01 | −6.4714E+02 |
| 3 | −2.0000E+01 | −1.9503E+00 | 1.4784E+00 | −4.6953E+01 | 4.2547E+02 |
| 4 | 1.2776E+00 | −5.7871E−01 | −2.2943E−01 | −1.6208E+00 | 2.2233E+01 |
| 5 | −2.0000E+01 | 3.7181E−01 | −1.5847E+00 | 7.7110E+00 | −3.1800E+01 |
| 6 | −4.0522E+00 | −1.4196E+00 | 8.0483E+00 | −3.5185E+01 | 1.1326E+02 |
| 7 | 1.9999E+01 | −1.0739E+00 | 1.2717E+00 | −6.5199E−01 | 1.3622E+00 |
| 8 | −4.5932E+00 | −7.2067E−01 | 1.4503E+00 | −2.1486E+00 | 2.0943E+00 |
| Surface | | | | | |
| Number | A12 | A14 | A16 | A18 | A20 |
| 1 | 1.3450E+04 | −6.8414E+04 | 1.3619E+05 | 0.0000E+00 | 0.0000E+00 |
| 2 | 4.8520E+03 | −1.7460E+04 | 2.3808E+04 | 0.0000E+00 | 0.0000E+00 |
| 3 | −2.1291E+03 | 6.6867E+03 | −8.4407E+03 | 0.0000E+00 | 0.0000E+00 |
| 4 | −1.2981E+02 | 3.7473E+02 | −3.6097E+02 | 0.0000E+00 | 0.0000E+00 |
| 5 | 5.4306E+01 | −4.0222E+01 | 1.2314E+01 | 0.0000E+00 | 0.0000E+00 |
| 6 | −2.1064E+02 | 2.0603E+02 | −8.2886E+01 | 0.0000E+00 | 0.0000E+00 |
| 7 | −6.1159E+00 | 9.6534E+00 | −4.8296E+00 | 0.0000E+00 | 0.0000E+00 |
| 8 | −1.2795E+00 | 4.3804E−01 | −6.3610E−02 | 0.0000E+00 | 0.0000E+00 |

### Second Embodiment

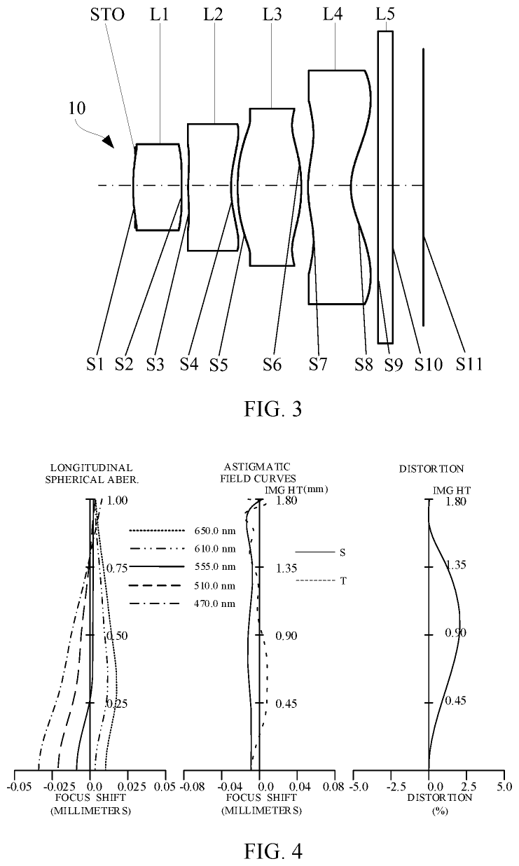

Referring to FIGS. 3 and 4, in the second embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the second embodiment is included in FIG. 4. The astigmatism diagram and the distortion diagram are graphs at a wavelength of 555 nm.

Ordinates of the astigmatism diagram and the distortion diagram are half of a diagonal length of an effective pixel area on an imaging plane S11 of the optical system 10, in unit of mm.

An object side surface S1 of the first lens L1 is convex at the optical axis and is convex at its circumference. An image side surface S2 of the first lens L1 is concave at the optical axis and is concave at its circumference.

An object side surface S3 of the second lens L2 is convex at the optical axis and is concave at its circumference. An image side surface S4 of the second lens L2 is concave at the optical axis and is convex at its circumference.

An object side surface S5 of the third lens L3 is convex at the optical axis and is concave at its circumference. An image side surface S6 of the third lens L3 is convex at the optical axis and is convex at its circumference.

An object side surface S7 of the fourth lens L4 is convex at the optical axis and concave at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the second embodiment, the effective focal length of the optical system 10 is indicated by f, and f=2.05 mm. The f-number is indicated by FNO, and FNO=3.05. The maximum angle of field of view (diagonal angle of field of view) is indicated by FOV, and FOV=68°. The total optical length is indicated by TTL, and TTL=4.4 mm.

In addition, various parameters of the lenses of the optical system 10 are shown in Table 3 and Table 4. Definitions of the various parameters can be obtained from the first embodiment, and which will not be repeated herein.

TABLE 3
Second Embodiment
f = 2.05 mm, FNO = 3.05, FOV = 68.0° , TTL = 4.4 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 8.825 | | | | |
| 0 | Stop | Spherical | Infinite | −0.032 | | | | |
| 1 | First Lens | Aspherical | 2.230 | 0.736 | Plastic | 1.55 | 56.11 | 4.39 |
| 2 | | Aspherical | 27.836 | 0.100 | | | | |
| 3 | Second Lens | Aspherical | 2.365 | 0.650 | Plastic | 1.64 | 23.52 | −6.25 |
| 4 | | Aspherical | 1.329 | 0.100 | | | | |
| 5 | Third Lens | Aspherical | 2.780 | 0.965 | Plastic | 1.55 | 56.11 | 2.08 |
| 6 | | Aspherical | −1.690 | 0.100 | | | | |
| 7 | Fourth Lens | Aspherical | 1.227 | 0.650 | Plastic | 1.55 | 56.11 | −6.54 |
| 8 | | Aspherical | 0.742 | 0.414 | | | | |
| 9 | Infrared | Aspherical | Infinite | 0.221 | Glass | 1.52 | 64.17 | |
| 10 | Cut-off Filter | Aspherical | Infinite | 0.465 | | | | |
| Image | Image plane | Spherical | Infinite | 0.000 | | | | |
| plane | | | | | | | | |

Note: the reference wavelength is 555 nm

TABLE 4
Second Embodiment
Aspheric Coefficient

| Surface | | | | | |
|---|---|---|---|---|---|
| Number | K | A4 | A6 | A8 | A10 |
| 1 | −3.2694E+00 | −4.8850E−02 | 1.4767E+00 | −2.7318E+01 | 2.7659E+02 |
| 2 | −1.0000E+01 | −8.6131E−01 | 5.9297E−01 | 1.1906E+01 | −9.6930E+01 |
| 3 | 9.9499E+00 | −1.1084E+00 | 5.3461E−01 | 2.6484E+00 | −1.4859E+01 |
| 4 | −1.1147E+00 | 4.1670E−02 | −2.3961E+00 | 8.5427E+00 | −1.8765E+01 |
| 5 | −4.9420E−02 | 6.9696E−01 | −2.4184E+00 | 5.2791E+00 | −6.9075E+00 |
| 6 | −1.0000E+01 | −5.1136E−01 | 2.0248E+00 | −4.9868E+00 | 8.5771E+00 |
| 7 | 7.3810E−02 | −8.4504E−01 | 1.4960E+00 | −4.2101E+00 | 7.4817E+00 |
| 8 | −1.6152E+00 | −4.8282E−01 | 3.5658E−01 | −1.8298E−01 | 6.8390E−02 |
| Surface | | | | | |
| Number | A12 | A14 | A16 | A18 | A20 |
| 1 | −1.5772E+03 | 4.7429E+03 | −5.8499E+03 | 0.0000E+00 | 0.0000E+00 |
| 2 | 3.9439E+02 | −8.3272E+02 | 7.2060E+02 | 0.0000E+00 | 0.0000E+00 |
| 3 | 4.9065E+01 | −9.7132E+01 | 7.7047E+01 | 0.0000E+00 | 0.0000E+00 |
| 4 | 2.5093E+01 | −1.9406E+01 | 6.5674E+00 | 0.0000E+00 | 0.0000E+00 |
| 5 | 4.1909E+00 | 1.4285E−01 | −1.1853E+00 | 0.0000E+00 | 0.0000E+00 |
| 6 | −7.8991E+00 | 3.3872E+00 | −5.0794E−01 | 0.0000E+00 | 0.0000E+00 |
| 7 | −7.5464E+00 | 4.0372E+00 | −9.0155E−01 | 0.0000E+00 | 0.0000E+00 |
| 8 | −2.5850E−02 | 8.7800E−03 | −1.4000E−03 | 0.0000E+00 | 0.0000E+00 |

From the above data, the following data can be obtained.

Second Embodiment

| | | | |
|---|---|---|---|
| M | 0.30 | (f1 + f3)/f | 3.156 |
| TT/Imgh | 7.329 | R1/R8 | 3.004 |
| TTL/Imgh | 2.444 | CT3/CT2 | 1.492 |
| f1/f2 | −0.702 | \|SAG41\|/CT4 | 0.015 |
| TTL/f | 2.146 | | |

### Third Embodiment

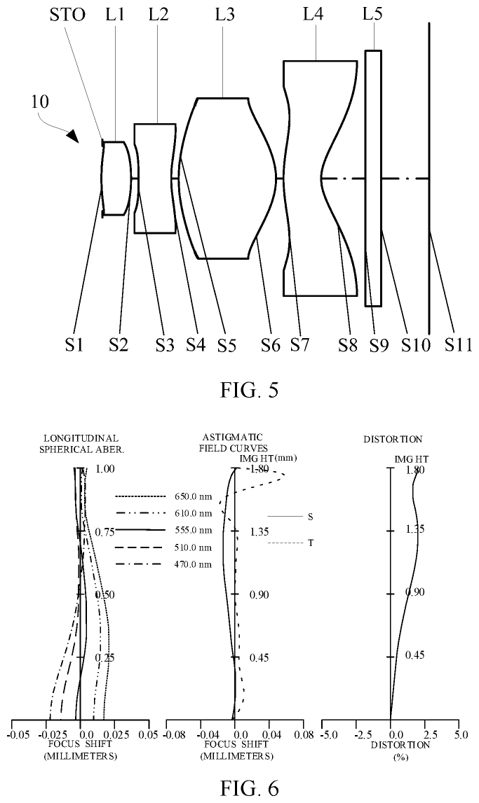

Referring to FIGS. 5 and 6, in the third embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the third embodiment is included in FIG. 6. The astigmatism diagram and the distortion diagram are graphs at a wavelength of 555 nm.

Ordinates of the astigmatism diagram and the distortion diagram are half of a diagonal length of an effective pixel area on an imaging plane S11 of the optical system 10, in unit of mm.

An object side surface S1 of the first lens L1 is convex at the optical axis and is concave at its circumference. An image side surface S2 of the first lens L1 is convex at the optical axis and is convex at its circumference.

An object side surface S3 of the second lens L2 is concave at the optical axis and is concave at its circumference. An image side surface S4 of the second lens L2 is concave at the optical axis and is convex at its circumference.

An object side surface S5 of the third lens L3 is convex at the optical axis and is convex at its circumference. An image side surface S6 of the third lens L3 is convex at the optical axis and is concave at its circumference.

An object side surface S7 of the fourth lens L4 is convex at the optical axis and concave at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the third embodiment, the effective focal length of the optical system 10 is indicated by f, and f=1.18 mm. The f-number is indicated by FNO, and FNO=3.05. The maximum angle of field of view (diagonal angle of field of view) is indicated by FOV, and FOV=76.0°. The total optical length is indicated by TTL, and TTL=4.38 mm.

In addition, various parameters of the lenses of the optical system 10 are shown in Table 5 and Table 6. Definitions of the various parameters can be obtained from the first embodiment, and which will not be repeated herein.

TABLE 5
Third Embodiment
f = 1.18mm, FNO = 3.05, FOV = 76.0° , TTL = 4.38 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 1.9 | | | | |
| 0 | Stop | Spherical | Infinite | −0.0139 | | | | |
| 1 | First Lens | Aspherical | 1.6523 | 0.3956 | Plastic | 1.55 | 56.11 | 1.63 |
| 2 | | Aspherical | −1.7767 | 0.1000 | | | | |
| 3 | Second Lens | Aspherical | −27.4309 | 0.4368 | Plastic | 1.64 | 23.52 | −1.65 |
| 4 | | Aspherical | 1.1098 | 0.1000 | | | | |
| 5 | Third Lens | Aspherical | 1.3889 | 1.3000 | Plastic | 1.55 | 56.11 | 1.03 |
| 6 | | Aspherical | −0.6328 | 0.1000 | | | | |
| 7 | Fourth Lens | Aspherical | 1.4085 | 0.5028 | Plastic | 1.55 | 56.11 | −1.21 |
| 8 | | Aspherical | 0.3922 | 0.5913 | | | | |
| 9 | Infrared | Aspherical | Infinite | 0.2100 | Glass | 1.52 | 64.17 | |
| 10 | Cut-off Filter | Aspherical | Infinite | 0.6404 | | | | |
| Image | Image plane | Spherical | Infinite | 0.0000 | | | | |
| plane | | | | | | | | |

Note: the reference wavelength is 555 nm

TABLE 6
Third Embodiment
Aspheric Coefficient

| Surface | | | | | |
|---|---|---|---|---|---|
| Number | K | A4 | A6 | A8 | A10 |
| 1 | 1.7192E+00 | −3.2826E−01 | 1.0496E+00 | −5.3337E+01 | 7.2312E+02 |
| 2 | 6.0185E+00 | −1.5874E+00 | 4.6083E+00 | −2.6688E+01 | 1.5005E+02 |
| 3 | −2.0000E+01 | −2.4661E+00 | 3.9566E+00 | −9.1939E+00 | −1.2948E+01 |
| 4 | −3.5833E+00 | −9.9266E−01 | 1.2710E+00 | 9.0941E−01 | −1.1072E+01 |
| 5 | −4.9701E+00 | 1.6853E−01 | −1.2844E+00 | 5.0826E+00 | −1.1944E+01 |
| 6 | −3.5050E+00 | −4.9313E−01 | 1.8878E+00 | −4.9139E+00 | 9.2172E+00 |
| 7 | −2.5265E+00 | −4.9779E−01 | 8.1327E−01 | −2.0347E+00 | 3.5811E+00 |
| 8 | −2.5946E+00 | −3.3381E−01 | 4.2951E−01 | −5.2376E−01 | 4.6465E−01 |
| Surface | | | | | |
| Number | A12 | A14 | A16 | A18 | A20 |
| 1 | −6.0839E+03 | 2.6015E+04 | −4.7691E+04 | 0.0000E+00 | 0.0000E+00 |
| 2 | −1.0188E+03 | 4.0293E+03 | −6.8234E+03 | 0.0000E+00 | 0.0000E+00 |
| 3 | 3.9765E+02 | −2.4585E+03 | 5.4425E+03 | 0.0000E+00 | 0.0000E+00 |
| 4 | 2.7317E+01 | −3.0483E+01 | 1.3715E+01 | 0.0000E+00 | 0.0000E+00 |
| 5 | 1.6982E+01 | −1.3231E+01 | 4.3418E+00 | 0.0000E+00 | 0.0000E+00 |
| 6 | −1.0472E+01 | 6.4379E+00 | −1.5820E+00 | 0.0000E+00 | 0.0000E+00 |
| 7 | −3.9536E+00 | 2.4142E+00 | −6.0307E−01 | 0.0000E+00 | 0.0000E+00 |
| 8 | −2.6693E−01 | 8.7510E−02 | −1.2240E−02 | 0.0000E+00 | 0.0000E+00 |

From the above data, the following data can be obtained.

Third Embodiment

| | | | |
|---|---|---|---|
| M | 1.22 | (f1 + f3)/f | 2.254 |
| TT/Imgh | 3.479 | R1/R8 | 4.213 |
| TTL/Imgh | 2.433 | CT3/CT2 | 2.955 |
| f1/f2 | −0.988 | \|SAG41\|/CT4 | 0.007 |
| TTL/f | 3.712 | | |

### Fourth Embodiment

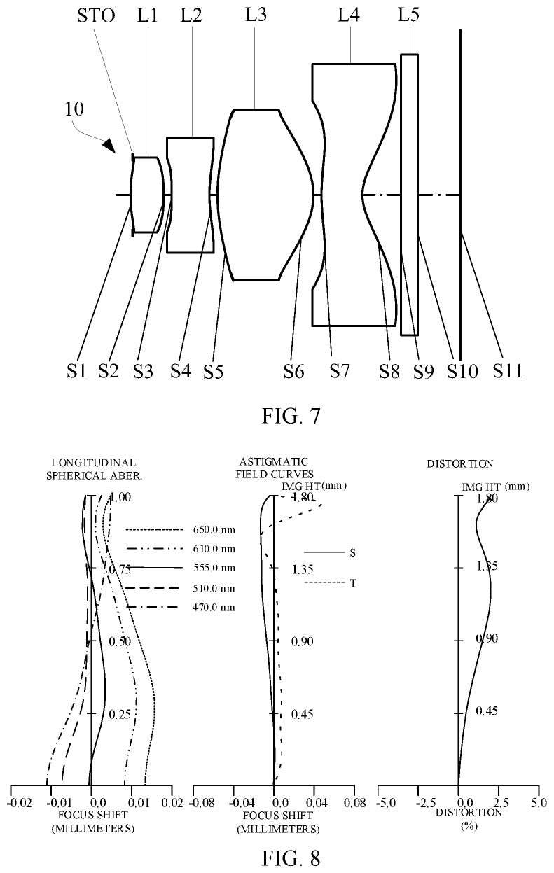

Referring to FIGS. 7 and 8, in the fourth embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the fourth embodiment is included in FIG. 8. The astigmatism diagram and the distortion diagram are graphs at a wavelength of 555 nm.

Ordinates of the astigmatism diagram and the distortion diagram are half of a diagonal length of an effective pixel area on an imaging plane S11 of the optical system 10, in unit of mm.

An object side surface S1 of the first lens L1 is convex at the optical axis and is concave at its circumference. An image side surface S2 of the first lens L1 is convex at the optical axis and is convex at its circumference.

An object side surface S3 of the second lens L2 is concave at the optical axis and is concave at its circumference. An image side surface S4 of the second lens L2 is concave at the optical axis and is convex at its circumference.

An object side surface S5 of the third lens L3 is convex at the optical axis and is convex at its circumference. An image side surface S6 of the third lens L3 is convex at the optical axis and is concave at its circumference.

An object side surface S7 of the fourth lens L4 is convex at the optical axis and concave at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the fourth embodiment, the effective focal length of the optical system 10 is indicated by f, and f=1.21 mm. The f-number is indicated by FNO, and FNO=3.05. The maximum angle of field of view (diagonal angle of field of view) is indicated by FOV, and FOV=76.0°. The total optical length is indicated by TTL, and TTL=4.38 mm.

In addition, various parameters of the lenses of the optical system 10 are shown in Table 7 and Table 8. Definitions of the various parameters can be obtained from the first embodiment, and which will not be repeated herein.

TABLE 7
Fourth Embodiment
f = 1.21 mm, FNO = 3.05, FOV = 76.0° , TTL = 4.38 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 2.305 | | | | |
| 0 | Stop | Spherical | Infinite | −0.0234 | | | | |
| 1 | First Lens | Aspherical | 1.422 | 0.4143 | Plastic | 1.55 | 56.11 | 1.50 |
| 2 | | Aspherical | −1.724 | 0.1000 | | | | |
| 3 | Second Lens | Aspherical | −5.038 | 0.4704 | Plastic | 1.64 | 23.52 | −1.59 |
| 4 | | Aspherical | 1.331 | 0.1000 | | | | |
| 5 | Third Lens | Aspherical | 1.670 | 1.2000 | Plastic | 1.55 | 56.11 | 1.00 |
| 6 | | Aspherical | −0.610 | 0.1000 | | | | |
| 7 | Fourth Lens | Aspherical | 1.885 | 0.5107 | Plastic | 1.55 | 56.11 | −1.09 |
| 8 | | Aspherical | 0.408 | 0.4820 | | | | |
| 9 | Infrared | Aspherical | Infinite | 0.2100 | Glass | 1.52 | 64.17 | |
| 10 | Cut−off Filter | Aspherical | Infinite | 0.5311 | | | | |
| Image | Image plane | Spherical | Infinite | 0.0000 | | | | |
| plane | | | | | | | | |

Note: the reference wavelength is 555 nm

TABLE 8
Fourth Embodiment
Aspheric Coefficient

| Surface | | | | | |
|---|---|---|---|---|---|
| Number | K | A4 | A6 | A8 | A10 |
| 1 | 2.2561E+00 | −3.1188E−01 | 1.1051E+00 | −5.5363E+01 | 7.8197E+02 |
| 2 | 3.8753E+00 | −1.1715E+00 | 2.5397E+00 | −2.1692E+01 | 1.3385E+02 |
| 3 | 1.0000E+01 | −1.9074E+00 | 3.2767E+00 | −2.2837E+01 | 1.0919E+02 |
| 4 | −2.6734E+00 | −8.6617E−01 | 1.4408E+00 | −2.2471E+00 | 4.8957E−01 |
| 5 | −7.7206E+00 | 9.0920E−02 | −7.3687E−01 | 2.8645E+00 | −7.5709E+00 |
| 6 | −3.3652E+00 | −5.0056E−01 | 1.7330E+00 | −4.8415E+00 | 1.0033E+01 |
| 7 | −4.2286E+00 | −5.0236E−01 | 5.3552E−01 | −1.2334E+00 | 2.5504E+00 |
| 8 | −2.7548E+00 | −3.8400E−01 | 5.3088E−01 | −6.0883E−01 | 4.7916E−01 |
| Surface | | | | | |
| Number | A12 | A14 | A16 | A18 | A20 |
| 1 | −6.6442E+03 | 2.8770E+04 | −5.2459E+04 | 0.0000E+00 | 0.0000E+00 |
| 2 | −9.1750E+02 | 3.7098E+03 | −6.5000E+03 | 0.0000E+00 | 0.0000E+00 |
| 3 | −1.4605E+02 | −1.3931E+03 | 5.1846E+03 | 0.0000E+00 | 0.0000E+00 |
| 4 | 9.2578E+00 | −2.1708E+01 | 1.7074E+01 | 0.0000E+00 | 0.0000E+00 |
| 5 | 1.2770E+01 | −1.1726E+01 | 4.4518E+00 | 0.0000E+00 | 0.0000E+00 |
| 6 | −1.2964E+01 | 9.2403E+00 | −2.7055E+00 | 0.0000E+00 | 0.0000E+00 |
| 7 | −3.5016E+00 | 2.5907E+00 | −7.5682E−01 | 0.0000E+00 | 0.0000E+00 |
| 8 | −2.4104E−01 | 6.9130E−02 | −8.4900E−03 | 0.0000E+00 | 0.0000E+00 |

From the above data, the following data can be obtained.

Fourth Embodiment

| | | | |
|---|---|---|---|
| M | 1.00 | (f1 + f3)/f | 2.066 |
| TT/Imgh | 3.556 | R1/R8 | 3.483 |
| TTL/Imgh | 2.289 | CT3/CT2 | 2.553 |
| f1/f2 | −0.943 | \|SAG41\|/CT4 | 0.223 |
| TTL/f | 3.405 | | |

### Fifth Embodiment

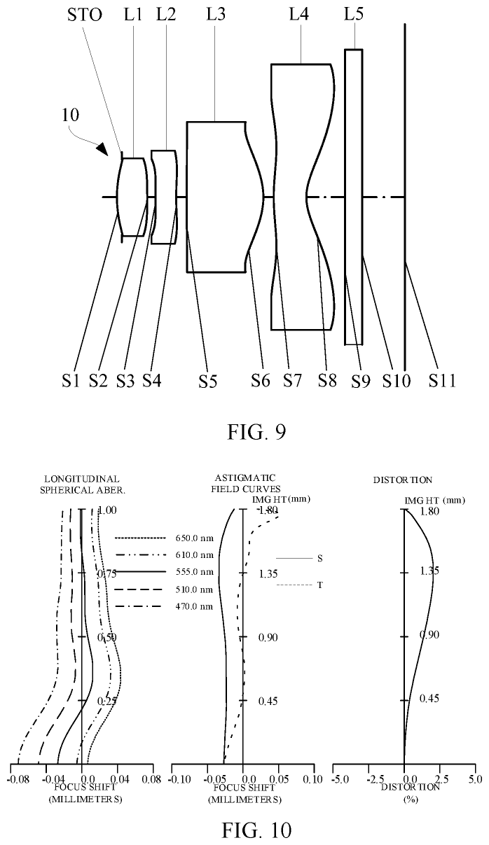

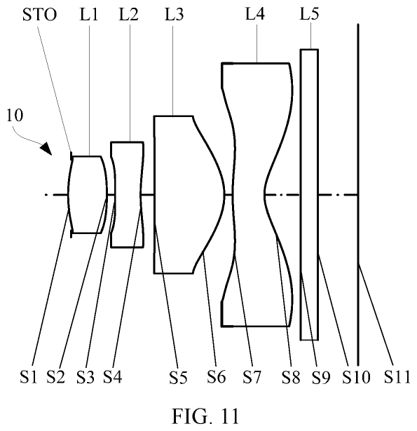

Referring to FIGS. 9 and 10, in the fifth embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the fifth embodiment is included in FIG. 10. The astigmatism diagram and the distortion diagram are graphs at a wavelength of 555 nm.

Ordinates of the astigmatism diagram and the distortion diagram are half of a diagonal length of an effective pixel area on an imaging plane S11 of the optical system 10, in unit of mm.

An object side surface S1 of the first lens L1 is convex at the optical axis and is concave at its circumference. An image side surface S2 of the first lens L1 is convex at the optical axis and is convex at its circumference.

An object side surface S3 of the second lens L2 is convex at the optical axis and is concave at its circumference. An image side surface S4 of the second lens L2 is concave at the optical axis and is convex at its circumference.

An object side surface S5 of the third lens L3 is concave at the optical axis and is concave at its circumference. An image side surface S6 of the third lens L3 is convex at the optical axis and is concave at its circumference.

An object side surface S7 of the fourth lens L4 is convex at the optical axis and concave at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the fifth embodiment, the effective focal length of the optical system 10 is indicated by f, and f=1.19 mm. The f-number is indicated by FNO, and FNO=3.05. The maximum angle of field of view (diagonal angle of field of view) is indicated by FOV, and FOV=74.1°. The total optical length is indicated by TTL, and TTL=3.50 mm.

In addition, various parameters of the lenses of the optical system 10 are shown in Table 9 and Table 10. Definitions of the various parameters can be obtained from the first embodiment, and which will not be repeated herein.

TABLE 9
Fifth Embodiment
f = 1.19m, FNO = 3.05, FOV = 74.1° , TTL = 3.50 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 2.659 | | | | |
| 0 | Stop | Spherical | Infinite | −0.059 | | | | |
| 1 | First Lens | Aspherical | 1.063 | 0.368 | Plastic | 1.55 | 56.11 | 1.70 |
| 2 | | Aspherical | −8.019 | 0.101 | | | | |
| 3 | Second Lens | Aspherical | 4.826 | 0.252 | Plastic | 1.64 | 23.52 | −8.05 |
| 4 | | Aspherical | 2.448 | 0.128 | | | | |
| 5 | Third Lens | Aspherical | −25.600 | 0.930 | Plastic | 1.55 | 56.11 | 1.14 |
| 6 | | Aspherical | −0.615 | 0.126 | | | | |
| 7 | Fourth Lens | Aspherical | 1.728 | 0.397 | Plastic | 1.55 | 56.11 | −1.13 |
| 8 | | Aspherical | 0.416 | 0.469 | | | | |
| 9 | Infrared | Aspherical | Infinite | 0.210 | Glass | 1.52 | 64.17 | |
| 10 | Cut-off Filter | Aspherical | Infinite | 0.518 | | | | |
| 11 | Image | Spherical | Infinite | 0.000 | | | | |
| | plane | | | | | | | |

Note: the reference wavelength is 555 nm

TABLE 10
Fifth Embodiment
Aspheric Coefficient

| Surface | | | | | |
|---|---|---|---|---|---|
| Number | K | A4 | A6 | A8 | A10 |
| 1 | −3.1163E+00 | 6.9400E−03 | −2.1100E−03 | −5.1000E−04 | 2.7000E−04 |
| 2 | −1.7839E+01 | 9.2100E−03 | −1.3740E−02 | 6.2900E−03 | −2.9200E−03 |
| 3 | −1.9168E+01 | 1.6610E−02 | −1.1830E−02 | 2.3800E−03 | 2.8200E−03 |
| 4 | −1.8366E−01 | −4.3400E−03 | 3.6700E−03 | −1.8700E−03 | −3.6300E−03 |
| 5 | −1.5000E+01 | −2.6200E−02 | 1.7310E−02 | −4.9900E−03 | −5.4900E−03 |
| 6 | −7.3660E+00 | −1.0450E−02 | 7.9900E−03 | 4.6400E−03 | −1.1370E−02 |
| 7 | −1.5000E+01 | −1.9160E−02 | 5.2600E−03 | −1.0250E−02 | 1.3370E−02 |
| 8 | −1.5000E+01 | −2.1450E−02 | 1.1600E−03 | −3.5700E−03 | 4.0500E−03 |
| Surface | | | | | |
| Number | A12 | A14 | A16 | A18 | A20 |
| 1 | −6.0000E−05 | −4.0000E−05 | 3.0000E−05 | −1.0000E−05 | 0.0000E+00 |
| 2 | 1.4200E−03 | −4.9000E−04 | 1.1000E−04 | −1.0000E−05 | 0.0000E+00 |
| 3 | −2.8600E−03 | 1.5600E−03 | −5.0000E−04 | 9.0000E−05 | −1.0000E−05 |
| 4 | 5.6200E−03 | −3.4100E−03 | 1.0800E−03 | −1.8000E−04 | 1.0000E−05 |
| 5 | 7.5600E−03 | −4.3600E−03 | 1.3800E−03 | −2.3000E−04 | 2.0000E−05 |
| 6 | 9.4500E−03 | −4.4900E−03 | 1.2800E−03 | −2.0000E−04 | 1.0000E−05 |
| 7 | −1.0650E−02 | 5.1600E−03 | −1.5000E−03 | 2.4000E−04 | −2.0000E−05 |
| 8 | −2.5200E−03 | 9.3000E−04 | −2.1000E−04 | 2.0000E−05 | 0.0000E+00 |

From the above data, the following data can be obtained.

Fifth Embodiment

| | | | |
|---|---|---|---|
| M | 0.90 | (f1 + f3)/f | 2.387 |
| TT/Imgh | 3.388 | R1/R8 | 2.552 |
| TTL/Imgh | 1.944 | CT3/CT2 | 3.720 |
| f1/f2 | −0.211 | \|SAG41\|/CT4 | 0.073 |
| TTL/f | 2.941 | | |

### Sixth Embodiment

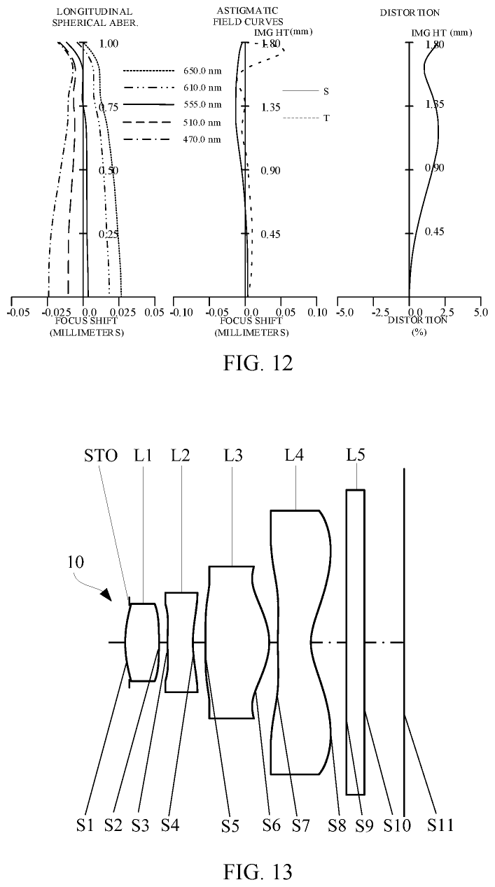

Referring to FIGS. 11 and 12, in the sixth embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the sixth embodiment is included in FIG. 12. The astigmatism diagram and the distortion diagram are graphs at a wavelength of 555 nm.

Ordinates of the astigmatism diagram and the distortion diagram are half of a diagonal length of an effective pixel area on an imaging plane S11 of the optical system 10, in unit of mm.

An object side surface S1 of the first lens L1 is convex at the optical axis and is concave at its circumference. An image side surface S2 of the first lens L1 is convex at the optical axis and is convex at its circumference.

An object side surface S3 of the second lens L2 is convex at the optical axis and is concave at its circumference. An image side surface S4 of the second lens L2 is concave at the optical axis and is convex at its circumference.

An object side surface S5 of the third lens L3 is concave at the optical axis and is concave at its circumference. An image side surface S6 of the third lens L3 is convex at the optical axis and is concave at its circumference.

An object side surface S7 of the fourth lens L4 is convex at the optical axis and convex at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the sixth embodiment, the effective focal length of the optical system 10 is indicated by f, and f=1.23 mm. The f-number is indicated by FNO, and FNO=3.05. The maximum angle of field of view (diagonal angle of field of view) is indicated by FOV, and FOV=76°. The total optical length is indicated by TTL, and TTL=3.52 mm.

In addition, various parameters of the lenses of the optical system 10 are shown in Table 11 and Table 12. Definitions of the various parameters can be obtained from the first embodiment, and which will not be repeated herein.

TABLE 11
Sixth Embodiment
f = 1.23 mm, FNO = 3.05, FOV = 76.0° , TTL = 3.52 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 2.7123 | | | | |
| 0 | Stop | Spherical | Infinite | −0.0353 | | | | |
| 1 | First Lens | Aspherical | 1.171 | 0.4699 | Plastic | 1.55 | 56.11 | 1.46 |
| 2 | | Aspherical | −2.164 | 0.1000 | | | | |
| 3 | Second Lens | Aspherical | 9.165 | 0.3096 | Plastic | 1.64 | 23.52 | −2.74 |
| 4 | | Aspherical | 1.458 | 0.1685 | | | | |
| 5 | Third Lens | Aspherical | −38.433 | 0.8500 | Plastic | 1.55 | 56.11 | 0.96 |
| 6 | | Aspherical | −0.520 | 0.1000 | | | | |
| 7 | Fourth Lens | Aspherical | 1.868 | 0.3860 | Plastic | 1.55 | 56.11 | −0.98 |
| 8 | | Aspherical | 0.385 | 0.4400 | | | | |
| 9 | Infrared | Aspherical | Infinite | 0.2100 | | | | |
| 10 | Cut-off Filter | Aspherical | Infinite | 0.4891 | Glass | 1.52 | 64.17 | |
| 11 | Image plane | Spherical | Infinite | 0.0000 | | | | |

Note: the reference wavelength is 555 nm

TABLE 12
Sixth Embodiment
Aspheric Coefficient

| Surface | | | | | |
|---|---|---|---|---|---|
| Number | K | A4 | A6 | A8 | A10 |
| 1 | −3.4066E+00 | 4.3670E−02 | −1.3346E+00 | 2.6037E+01 | −6.3487E+02 |
| 2 | 2.6459E+00 | −1.7252E+00 | 6.7891E+00 | −6.3775E+01 | 4.1861E+02 |
| 3 | 2.0000E+01 | −2.6100E+00 | 4.5255E+00 | −2.9940E+01 | 2.0742E+02 |
| 4 | −1.2092E+00 | −1.0122E+00 | 4.3340E−02 | 9.3051E+00 | −6.0409E+01 |
| 5 | −2.0000E+01 | 3.5973E−01 | −1.7685E+00 | 6.0888E+00 | −2.3104E+01 |
| 6 | −3.2943E+00 | −5.4815E−01 | 1.7859E+00 | −5.2025E+00 | 1.3493E+01 |
| 7 | −5.9071E+00 | −6.6266E−01 | 5.0215E−01 | 2.7073E−01 | −1.5629E+00 |
| 8 | −3.1675E+00 | −5.1695E−01 | 8.5400E−01 | −1.0908E+00 | 9.2916E−01 |
| Surface | | | | | |
| Number | A12 | A14 | A16 | A18 | A20 |
| 1 | 6.8376E+03 | −3.6605E+04 | 7.5257E+04 | 0.0000E+00 | 0.0000E+00 |
| 2 | −1.6785E+03 | 3.1718E+03 | −1.7088E+03 | 0.0000E+00 | 0.0000E+00 |
| 3 | −8.2917E+02 | 2.0082E+03 | −1.9236E+03 | 0.0000E+00 | 0.0000E+00 |
| 4 | 2.2161E+02 | −4.3706E+02 | 3.6870E+02 | 0.0000E+00 | 0.0000E+00 |
| 5 | 5.8420E+01 | −7.9200E+01 | 4.5123E+01 | 0.0000E+00 | 0.0000E+00 |
| 6 | −2.3105E+01 | 2.2759E+01 | −9.2361E+00 | 0.0000E+00 | 0.0000E+00 |
| 7 | 2.0764E+00 | −1.1429E+00 | 2.2077E−01 | 0.0000E+00 | 0.0000E+00 |
| 8 | −4.9616E−01 | 1.4875E−01 | −1.8900E−02 | 0.0000E+00 | 0.0000E+00 |

From the above data, the following data can be obtained.

Sixth Embodiment

| | | | |
|---|---|---|---|
| M | 0.85 | (f1 + f3)/f | 1.967 |
| TT/Imgh | 3.444 | R1/R8 | 3.042 |
| TTL/Imgh | 1.956 | CT3/CT2 | 2.742 |
| f1/f2 | −0.533 | \|SAG41\|/CT4 | 0.256 |
| TTL/f | 2.862 | | |

### Seventh Embodiment

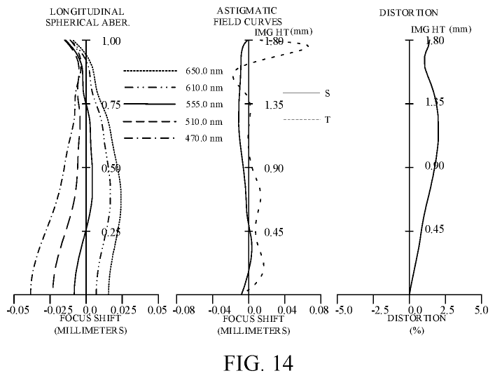

Referring to FIGS. 13 and 14, in the seventh embodiment, the optical system 10 includes, sequentially from an object side to an image side, a stop STO, a first lens L1 having a positive refractive power, a second lens L2 having a negative refractive power, a third lens L3 having a positive refractive power, and a fourth lens L4 having a negative refractive power. A spherical aberration diagram (mm), an astigmatism diagram (mm), and a distortion diagram (%) of the optical system 10 in the seventh embodiment is included in FIG. 14. The astigmatism diagram and the distortion diagram are graphs at a wavelength of 555 nm.

Ordinates of the astigmatism diagram and the distortion diagram are half of a diagonal length of an effective pixel area on an imaging plane S11 of the optical system 10, in unit of mm.

An object side surface S1 of the first lens L1 is convex at the optical axis and is concave at its circumference. An image side surface S2 of the first lens L1 is convex at the optical axis and is convex at its circumference.

An object side surface S3 of the second lens L2 is convex at the optical axis and is concave at its circumference. An image side surface S4 of the second lens L2 is concave at the optical axis and is convex at its circumference.

An object side surface S5 of the third lens L3 is convex at the optical axis and is concave at its circumference. An image side surface S6 of the third lens L3 is convex at the optical axis and is concave at its circumference.

An object side surface S7 of the fourth lens L4 is convex at the optical axis and concave at the circumference. An image side surface S8 of the fourth lens L4 is concave at the optical axis and is convex at its circumference. The object side surface S7 and the image side surface S8 of the fourth lens L4 have inflection points. Since the image side surface S8 of the fourth lens L4 has the inflection point, and the image side surface S8 is concave at the optical axis and convex at its circumference, it is beneficial to shorten the total length of the optical system 10 and effectively reduce the incidence angle of the light when being incident from an edge of field of view onto the imaging plane S11, improving the light-receiving efficiency of a photosensitive element on the imaging plane S11.

The object side surfaces and the image side surfaces of the first lens L1, the second lens L2, the third lens L3, and the fourth lens L4 are all aspherical. By matching the aspheric surface shapes of the lenses in the optical system 10, the problem of distortion of the field of view of the optical system 10 can be effectively solved, and the lenses can achieve excellent optical effects even when the lenses are small and thin. As such, the optical system 10 has a smaller volume, which is beneficial to the miniaturized design of the optical system 10.

The first lens L1, the second lens L2, the third lens L3, and the fourth lens L4 are all made of plastic. The adoption of the lenses made of plastic can reduce the manufacturing cost of the optical system 10 while reducing the weight of the optical system 10.

An infrared cut-off filter L5 is further arranged on an image side of the fourth lens L4 for filtering infrared light. In some embodiments, the infrared cut-off filter L5 is a part of the optical system 10. For example, the infrared cut-off filter L5 is assembled on a lens barrel together with the lenses. In other embodiments, the infrared cut-off filter L5 may be mounted between the optical system 10 and the photosensitive element when the optical system 10 and the photosensitive element are assembled into a camera module.

In the seventh embodiment, the effective focal length of the optical system 10 is indicated by f, and f=1.34 mm. The f-number is indicated by FNO, and FNO=3.05. The maximum angle of field of view (diagonal angle of field of view) is indicated by FOV, and FOV=73.8°. The total optical length is indicated by TTL, and TTL=3.27 mm.

In addition, various parameters of the lenses of the optical system 10 are shown in Table 13 and Table 14. Definitions of the various parameters can be obtained from the first embodiment, and which will not be repeated herein.

TABLE 13
Seventh Embodiment
f = 1.34 mm, FNO = 3.05, FOV = 73.8° , TTL = 3.27 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| | Object plane | Spherical | Infinite | 3.582 | | | | |
| 0 | Stop | Spherical | Infinite | −0.047 | | | | |
| 1 | First Lens | Aspherical | 1.062 | 0.395 | Plastic | 1.55 | 56.11 | 1.73 |
| 2 | | Aspherical | −7.559 | 0.100 | | | | |
| 3 | Second Lens | Aspherical | 2.447 | 0.297 | Plastic | 1.64 | 23.52 | −3.91 |
| 4 | | Aspherical | 1.182 | 0.146 | | | | |
| 5 | Third Lens | Aspherical | 250.000 | 0.747 | Plastic | 1.55 | 56.11 | 1.01 |
| 6 | | Aspherical | −0.553 | 0.100 | | | | |
| 7 | Fourth Lens | Aspherical | 4.046 | 0.387 | Plastic | 1.55 | 56.11 | −1.02 |
| 8 | | Aspherical | 0.474 | 0.417 | | | | |
| 9 | Infrared | Aspherical | Infinite | 0.210 | | | | |
| 10 | Cut-off Filter | Aspherical | Infinite | 0.466 | Glass | 1.52 | 64.17 | |
| 11 | Image plane | Spherical | Infinite | 0.000 | | | | |

Note the reference wavelength is 555 nm

TABLE 14
Seventh Embodiment
Aspheric Coefficient

| Surface | | | | | |
|---|---|---|---|---|---|
| Number | K | A4 | A6 | A8 | A10 |
| 1 | −2.9605E+00 | 1.3198E−01 | −2.0011E+00 | 4.8685E+01 | −9.3114E+02 |
| 2 | −1.0000E+01 | −1.6987E+00 | 8.5889E−01 | 3.2312E+01 | −5.0849E+02 |
| 3 | 1.2435E+01 | −2.5834E+00 | 4.3623E−01 | −1.1644E+01 | 2.1534E+02 |
| 4 | −1.2112E+00 | −7.3842E−01 | −2.1867E+00 | 1.2198E+01 | −1.0631E+01 |
| 5 | 1.0000E+01 | 7.8026E−01 | −9.9311E−01 | −2.8692E+00 | 1.6899E+01 |
| 6 | −5.1837E+00 | −1.3386E+00 | 9.0955E+00 | −3.6267E+01 | 1.0292E+02 |
| 7 | 9.9126E+00 | −7.1134E−01 | 5.8699E−01 | 3.3861E−01 | −1.1122E+00 |
| 8 | −4.0588E+00 | −5.7626E−01 | 1.0139E+00 | −1.3827E+00 | 1.2682E+00 |
| Surface | | | | | |
| Number | A12 | A14 | A16 | A18 | A20 |
| 1 | 8.6696E+03 | −4.0944E+04 | 7.5841E+04 | 0.0000E+00 | 0.0000E+00 |
| 2 | 3.4359E+03 | −1.1498E+04 | 1.5055E+04 | 0.0000E+00 | 0.0000E+00 |
| 3 | −1.2948E+03 | 4.1975E+03 | −5.0896E+03 | 0.0000E+00 | 0.0000E+00 |
| 4 | −1.0783E+02 | 3.8218E+02 | −3.5704E+02 | 0.0000E+00 | 0.0000E+00 |
| 5 | −4.2550E+01 | 3.8464E+01 | −5.4207E+00 | 0.0000E+00 | 0.0000E+00 |
| 6 | −1.6574E+02 | 1.3305E+02 | −4.1206E+01 | 0.0000E+00 | 0.0000E+00 |
| 7 | 1.1884E+00 | −6.7977E−01 | 1.5327E−01 | 0.0000E+00 | 0.0000E+00 |
| 8 | −7.3807E−01 | 2.4239E−01 | −3.3940E−02 | 0.0000E+00 | 0.0000E+00 |

From the above data, the following data can be obtained.

Seventh Embodiment

| | | | |
|---|---|---|---|
| M | 0.67 | (f1 + f3)/f | 2.045 |
| TT/Imgh | 3.778 | R1/R8 | 2.239 |
| TTL/Imgh | 1.817 | CT3/CT2 | 2.500 |
| f1/f2 | −0.442 | \|SAG41\|/CT4 | 0.242 |
| TTL/f | 2.440 | | |

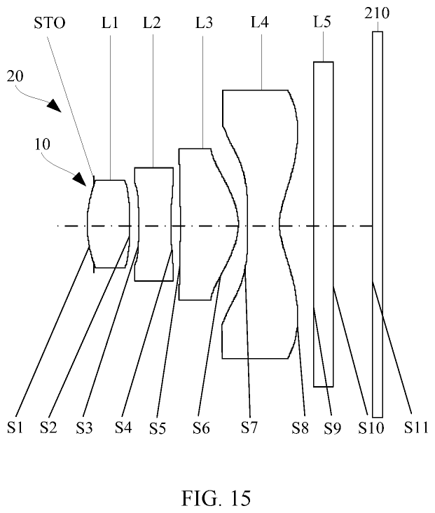

Referring to FIG. 15, in an embodiment according to the present disclosure, the optical system 10 and a photosensitive element 210 are assembled to form a camera module 20. As such, in this embodiment, an infrared cut-off filter L5 is arranged between the fourth lens L4 and the photosensitive element 210. The photosensitive element 210 may be a Charge Coupled Device (CCD) or a Complementary Metal Oxide Semiconductor (CMOS). By adopting the above optical system 10, the camera module 20 can achieve a miniaturized design, and can also obtain more clear details of the subject during macro capturing.

In some embodiments, the distance between the photosensitive element 210 and each of the lenses in the optical system 10 is relatively fixed. As such, the camera module 20 is a fixed focus module. In other embodiments, a driving mechanism such as a voice coil motor may be provided to enable the photosensitive element 210 to move relative to each of the lenses in the optical system 10, thereby achieving a focusing effect. In some embodiments, a driving mechanism can also be provided to drive part of the lenses in the optical system 10 to move, so as to achieve an optical zooming effect.

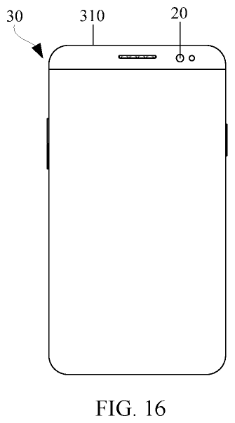

Referring to FIG. 16, some embodiments of the present disclosure further provide an electronic device 30. The camera module 20 is applied to the electronic device 30. Specifically, the electronic device 30 includes a housing 310. The camera module 20 is mounted on the housing 310. The housing 310 may be a circuit board, a middle frame, or the like. The electronic device 30 includes, but is not limited to, smart phones, smart watches, e-book readers, in-vehicle camera devices, monitoring devices, medical devices (such as endoscopes), tablet computers, biometric devices (such as fingerprint recognition devices or pupil recognition devices), personal digital assistants (PDAs), unmanned aerial vehicles, etc. Specifically, in some embodiments, the camera module 20 is applied to the smart phone. The smart phone includes a middle frame and a circuit board provided in the middle frame. The camera module 20 is mounted in the middle frame of the smart phone. The photosensitive element therein is electrically connected to the circuit board. The camera module 20 can be used as a front camera module or a rear camera module of a smart phone. By adopting the above camera module 20, the electronic device 30 has excellent macro capturing capability.

The “electronic device” used in the embodiments of the present disclosure may include, but is not limited to, a device configured to be connected via a wired line connection (such as via a public switched telephone network (PSTN), digital subscriber line (DSL), digital cable, direct cable connection, and/or another data connection/network) and/or receive/transmit communication signals via an wireless interface (for example, for a cellular network, a wireless local area network (WLAN), a digital TV network such as digital video broadcasting handheld (DVB-H) network, a satellite network, an amplitude modulation-frequency modulation (AM-FM) broadcast transmitter, and/or another communication terminal). The electronic device configured to communicate via the wireless interface may be referred to as a “wireless communication terminal”, a “wireless terminal” and/or a “mobile terminal”. Examples of the mobile terminal include, but is not limited to satellite or cellular phones; personal communication system (PCS) terminals that can combine cellular radio phones with data processing, fax, and data communication capabilities. Examples of the mobile terminal can include a radio phone, a pager, an Internet/intranet access, a Web browser, a memo pad, a calendar, and/or a personal digital assistant (PDA) of the global positioning system (GPS) receiver; and conventional laptop and/or handheld receiver or other electronic device including a radio phone transceiver.

In the description of the present disclosure, it should be understood that orientation or positional conditions indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” etc. are based on orientation or positional condition shown in the drawings, which are merely to facilitate the description of the present disclosure and simplify the description, not to indicate or imply that the device or elements must have a particular orientation, be constructed and operated in a particular orientation, and therefore cannot be construed as a limitation on the present disclosure.

In addition, the terms “first” and “second” are used for description only, and cannot be understood as indicating or implying relative importance or implicitly indicating the number of technical features indicated. Thus, the features defined with “first” and “second” may include at least one of the features explicitly or implicitly. In the description of the present disclosure, the meaning of “plurality” is at least two, for example, two, three or the like, unless explicitly and specifically defined otherwise.

In the present disclosure, unless explicitly specified and defined otherwise, terms “mounting”, “connecting”, “connected”, and “fixing” should be understood in a broad sense. For example, it may be a fixed connection or a detachable connection, or an integration; may be a mechanical connection or electrical connection; may be a direct connection, or may be a connection through an intermediate medium, may be the communication between two elements or the interaction between two elements, unless explicitly defined otherwise. The specific meanings of the above terms in the present disclosure can be understood by one of those ordinary skills in the art according to specific circumstances.

In the present disclosure, unless expressly specified and defined otherwise, a first feature being “on” or “below” a second feature may mean that the first feature is in direct contact with the second feature, or may mean that the first feature is indirectly contact with the second feature through an intermediate medium. Moreover, the first feature being “above”, “top” and “upside” on the second feature may mean that the first feature is directly above or obliquely above the second feature, or simply mean that the level of the first feature is higher than that of the second feature. The first feature being “below”, “under” and “beneath” the second feature may mean that the first feature is directly below or obliquely below the second feature, or simply mean that the level of the first feature is smaller than that of the second feature.

In the description of this specification, descriptions referring to terms “one embodiment”, “some embodiments”, “examples”, “specific examples”, or “some examples” and the like mean that specific features, structures, materials, or characteristics described in conjunction with the embodiment or example are included in at least one embodiment or example of the present disclosure. In this specification, schematic representations of the above terms do not necessarily refer to the same embodiment or example. Moreover, the described specific features, structures, materials, or characteristics can be combined in any one or more embodiments or examples in a suitable manner. In addition, if there is no contradiction, the different embodiments or examples and the features of the different embodiments or examples described in this specification can be combined and incorporated by those skilled in the art.

The technical features of the above-mentioned embodiments can be combined arbitrarily. In order to simply the description, all possible combinations of the technical features in the above-mentioned embodiments are not described. However, as long as there is no contradiction in the combinations of these technical features, they should be considered to be fallen into the range described in the present specification.

Only several embodiments of the present disclosure are illustrated in the above-mentioned embodiments, and the description thereof is relatively specific and detailed, but it should not be understood as a limitation on the scope of the present disclosure. It should be noted that for those of ordinary skill in the art, without departing from the concept of the present disclosure, several modifications and improvements can be made, which all fall within the protection scope of the present disclosure. Therefore, the protection scope of the present disclosure shall be subject to the appended claims.

What is claimed is:

1. An optical system, comprising, sequentially from an object side to an image side:
a first lens having a positive refractive power, an object side surface of the first lens being convex at an optical axis;
a second lens having a negative refractive power, an image side surface of the second lens being concave at the optical axis;
a third lens having a positive refractive power, and an image side surface of the third lens being convex at the optical axis; and
a fourth lens having a negative refractive power, and an image side surface of the fourth lens being concave at the optical axis;
wherein the optical system further satisfies a condition:
0.28<M<1.3;
wherein M is a magnification of the optical system.

2. The optical system according to claim 1, further satisfying the following condition:
3.3<TT/Imgh<7.4;
wherein TT is a distance from an object plane to an imaging plane of the optical system on the optical axis, and Imgh is half of a diagonal length of an effective pixel area on the imaging plane of the optical system.

3. The optical system according to claim 1, further satisfying the following condition:
TTL/Imgh<2.5;
wherein TTL is a distance from the object side surface of the first lens to an imaging plane of the optical system on the optical axis, and Imgh is half of a diagonal length of an effective pixel area on the imaging plane of the optical system.

4. The optical system according to claim 1, further satisfying the following condition:
−1<f1/f2<0;
wherein f1 is an effective focal length of the first lens, and f2 is an effective focal length of the second lens.

5. The optical system according to claim 1, further satisfying the following condition:
2<TTL/f<4;
wherein TTL is a distance from the object side of the first lens to an imaging plane of the optical system on the optical axis, and f is an effective focal length of the optical system.

6. The optical system according to claim 1, further satisfying the following condition:
1.8<(f1+f3)/f<3.2;
wherein f1 is an effective focal length of the first lens, f3 is an effective focal length of the third lens, and f is an effective focal length of the optical system.

7. The optical system according to claim 1, further satisfying the following condition:
2<R1/R8<4.5;
wherein R1 is a radius of curvature of the object side surface of the first lens at the optical axis, and R8 is a radius of curvature of the image side surface of the fourth lens at the optical axis.

8. The optical system according to claim 1, further satisfying the following condition:
1.4<CT3/CT2<4;
wherein CT3 is a thickness of the third lens on the optical axis, and CT2 is a thickness of the second lens on the optical axis.

9. The optical system according to claim 1, further satisfying the following condition:
0<|SAG41|/CT4<0.7;
wherein SAG41 is a sagittal height of an object side surface of the fourth lens, and CT4 is a thickness of the fourth lens on the optical axis.

10. The optical system according to claim 1, wherein at least one of object side surfaces and image side surfaces of the lenses of the optical system is aspherical.

11. The optical system according to claim 1, wherein the lenses of the optical system are made of plastic.

12. The optical system according to claim 1, wherein the lenses of the optical system are made of glass.

13. The optical system according to claim 1, wherein relative positions between the lenses of the optical system are fixed.

14. The optical system according to claim 1, further comprising an infrared cut-off filter arranged on an image side of the fourth lens.

15. The optical system according to claim 1, further comprising a stop arranged on an object side of the first lens.

16. The optical system according to claim 1, further comprising a stop arranged between adjacent two lenses of the optical system.

17. A camera module, comprising:
a photosensitive element; and
the optical system according to claim 1, wherein the photosensitive element is arranged on an image side of the fourth lens.

18. The camera module according to claim 17, wherein a distance between the photosensitive element and each of the lenses of the optical system is relatively fixed.

19. An electronic device, comprising:
a housing; and
the camera module according to claim 17,
wherein the camera module is provided on the housing.
